(19) United States
(12) Patent Application Publication
(10) Pub. No.: US 2008/0013727 A1
(43) Pub. Date: Jan. 17, 2008

(54) IMAGE PROCESSING APPARATUS AND IMAGE PROCESSING METHOD

(76) Inventor: Noboru UEMURA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/766,372

(22) Filed: Jun. 21, 2007

(30) Foreign Application Priority Data
Jun. 30, 2006 (JP) 2006-182200
Jun. 19, 2007 (JP) 2007-160921

(51) Int. Cl. H04N 1/44

(52) U.S. Cl. 380/243

(57) ABSTRACT

An image processing apparatus for scanning and printing out an original document is disclosed, including a setting part setting an encryption degree for encrypting contents in a range in the original document to become difficult to visually determine, for each of one or more ranges which are set to partially secure the original document.

### BACKGROUND OF THE INVENTION

1. Field of the Invention

The present invention generally relates to an image processing apparatus and an image processing method, and more particularly to the image processing apparatus and the image processing method for reading an original document in which at least one range being partially secured within a page of the original document can be set and encrypted to print out and display.

2. Description of the Related Art

Recently, since a copier and a printer have been widely used, a paper original document can be easily copied and a digital document can be easily printed out.

Accordingly, Japanese Laid-open Patent Application No. 9-65148 discloses a technology in which in order to prevent contents of a document from being looked at by others when the document is printed out from the printer, a user is authenticated at the printer to verify the user himself who attempts to print out the document before a printed document is output.

Conventionally, a digital document, image data and a like can be encrypted to be secured. However, there are cases in that a decryption key is leaked out to a third party and encrypted image data is illegally decrypted by the decryption key. Accordingly, Japanese Laid-open Patent Application No. 2005-271586 discloses a technology for confirming validity of decrypted image data when the encrypted image data are decrypted.

In conventional technologies as described above, it is assumed that a person having a specific authority is allowed to access the document and the image data. An object of the conventional technologies is to secure the entire document or image data. Disadvantageously, it is difficult for persons having a different authority to handles the same document based on each of their authorities.

### SUMMARY OF THE INVENTION

The present invention solves or reduces one or more of the above problems.

According to one aspect of the present invention, there is provided an image processing apparatus for scanning and printing out an original document is disclosed, including a setting part setting an encryption degree for encrypting contents in a range in the original document to become difficult to visually determine, for each of one or more ranges which are set to partially secure the original document.

According to the present invention, it is possible to set the encryption degree for each of one or more ranges to be secured with respect to a scanned original document. For example, it is possible to encrypt each of one or more ranges to be secured in a degree in that a presence of the contents may be darkly determined but cannot be readable, and to print out or display the original document with partially encrypted portions in one page. Moreover, since the encryption process is conducted partially to the original document, it is possible to prevent the entire document or image from being unreadable.

### BRIEF DESCRIPTION OF THE DRAWINGS

In the following, embodiments of the present invention will be described with reference to the accompanying drawings.

FIG. 1 is a diagram for briefly explaining a method for partially securing a document according to an embodiment of the present invention;

FIG. 2 is a diagram illustrating a screen allowing confidential level settings for security protection, according to the embodiment of the present invention;

FIG. 3 is a diagram illustrating another way of the confidential level settings for the security protection, according to the embodiment of the present invention;

FIG. 4A and FIG. 4B are different outputs based on an encryption degree according to the embodiment of the present invention;

FIG. 5 is a diagram showing a configuration of the image processing apparatus according to the embodiment of the present invention;

FIG. 6 is a diagram showing a system configuration formed by the image processing apparatus and a PC, according to the embodiment of the present invention;

FIG. 7 is a diagram showing a system configuration formed by the image processing apparatus, an authentication server, and a document server, according to the embodiment of the present invention;

FIG. 8 is a diagram showing a functional configuration of the image processing apparatus shown in FIG. 6, according to the embodiment of the present invention;

FIG. 9 is a diagram showing the process sequence in a case in that confidential level settings are performed when an original document is scanned, according to the embodiment of the present invention;

FIG. 10 is a diagram showing a process sequence in a case in that the confidential level setting is determined beforehand, according to the embodiment of the present invention;

FIG. 11 is a diagram for explaining a process sequence in a case in that a document manager conducts the confidential level setting from a PC, according to the embodiment of the present invention;

FIG. 12 is a diagram showing a process sequence in a case in that mark sheet portions are analyzed by the original document shown in FIG. 3 and the confidential level setting is determined, according to the embodiment of the present invention;

FIG. 13 is a diagram showing a process sequence for previewing an image being partially encrypted based on an authentication level, according to the embodiment of the present invention;

FIG. 14 is a diagram for explaining a process sequence for encrypting a confidential area in the original document and storing image data, according to the embodiment of the present invention;

FIG. 15 is a diagram for explaining a process sequence for displaying a preview image based on the image data in which one or more portions are decrypted by corresponding to the authentication level, according to the embodiment of the present invention;

FIG. 16 is a flowchart for explaining a confidential level information generation process according to the embodiment of the present invention;

FIG. 17 is a flowchart for explaining an encryption process according to the embodiment of the present invention;

FIG. 18 is a flowchart for explaining a decryption process according to the embodiment of the present invention;

FIG. 19 is a diagram showing a user information table stored in the user information storage part according to the embodiment of the present invention;

FIG. 20 is a diagram showing the confidential level setting information according to the embodiment of the present invention;

FIG. 21A and FIG. 21B are diagrams showing storage examples of the confidential level setting information according to the embodiment of the present invention;

### DESCRIPTION OF THE PREFERRED EMBODIMENTS

In the following, an embodiment of the present invention will be described with reference to the accompanying drawings.

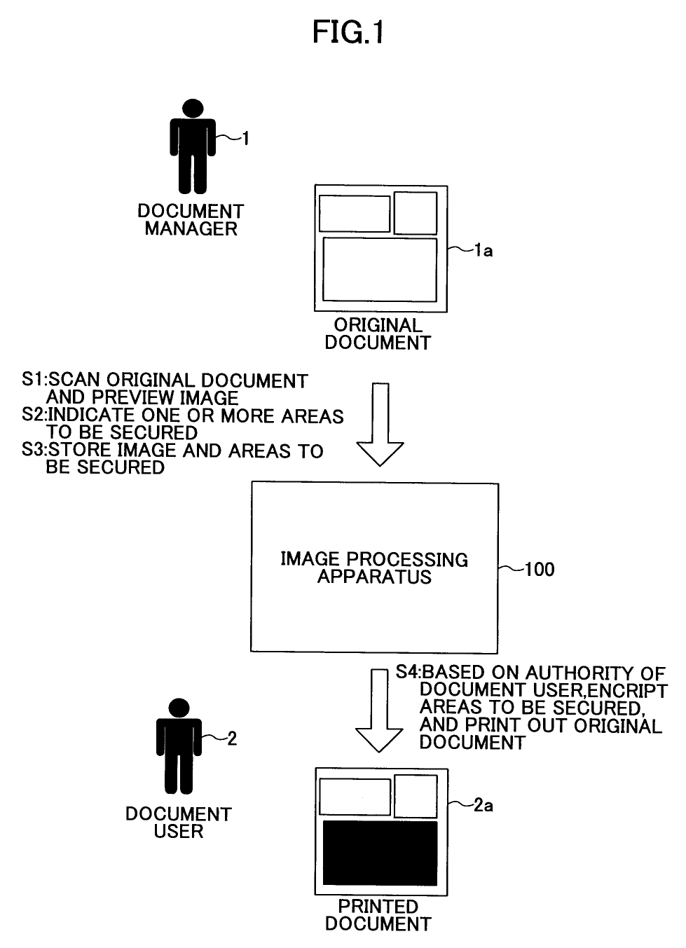

FIG. 1 is a diagram for briefly explaining a method for partially securing a document according to the embodiment of the present invention. In FIG. 1, a document manager 1 sets an original document 1a, which is a paper document and needed to be partially secured, onto an image processing apparatus 100, and displays a preview of the original document 1a scanned by the image processing apparatus 100 (step S1).

The document manager 1 indicates an area which the document manager 1 desires to secure, on a previewed image of the original document 1a (step S2). The document manager 1 may indicate a plurality of areas to secure. The image processing apparatus 100 stores an image generated by scanning the original document 1a and the area to be secured in an internal storage area (step S3).

Next, when a document user 2 attempts to print out the image of the original document 1a stored in the image processing apparatus 100, the image processing apparatus 100 encrypts one or more portions to be secured in an area of one page (hereinafter, called a page area) of the original document 1a based on an authority of the document user 1, and outputs a printed document 2a (step S4).

The printed document 2a is partially painted to secure one or more portions of the original document 1a in the page area and is output from the image processing apparatus. Accordingly, it is possible to protect one or more portions of the original document 1a.

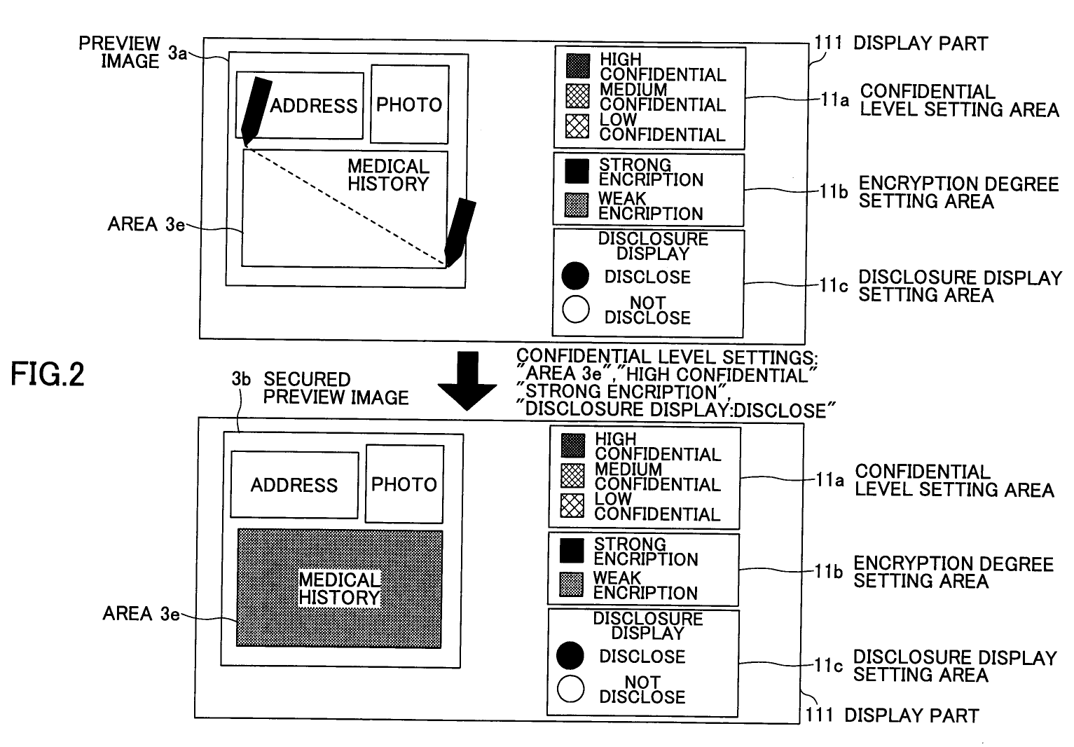

FIG. 2 is a diagram illustrating a screen allowing confidential level settings for security protection, according to the embodiment of the present invention. In FIG. 2, when the document manager 1 scans the original document 1a by the image processing apparatus 100, a display part 111 of the image processing apparatus 100 displays a preview image 3a displaying the image of the original document 1a, a confidential level setting area 11a for setting a confidential level, an encryption degree setting area 11b for setting an encryption degree, and a disclosure display setting area 11c for setting whether or not contents of the original document 1a are disclosed.

The confidential level setting area 11a is used to set the confidential level corresponding to each portion of the security protection in the original document 1a. In the confidential level setting area 11a, “HIGH CONFIDENTIAL” indicating a high level of the confidential, “MEDIUM CONFIDENTIAL” indicating a medium level of the confidential, and “LOW CONFIDENTIAL” indicating a low level of the confidential are displayed as selective items.

Contents are disclosed in a portion of the security protection of the original document 1a to which “HIGH CONFIDENTIAL” is set, when the authority level of the document user 2 indicates “HIGH CONFIDENTIAL”. If the authority level indicates “MEDIUM CONFIDENTIAL” or “LOW CONFIDENTIAL” lower than “HIGH CONFIDENTIAL”, the contents are encrypted by corresponding to the encryption degree, so that the contents are not disclosed.

Contents are disclosed in a portion of the security protection of the original document 1a to which “MEDIUM CONFIDENTIAL” is set, when the authority level of the document user 2 indicates “HIGH CONFIDENTIAL” or “MEDIUM CONFIDENTIAL”, If the authority level indicates “LOW CONFIDENTIAL” lower than “MEDIUM CONFIDENTIAL”, the contents are encrypted by corresponding to the encryption degree, so that the contents are not disclosed.

Contents are disclosed in a portion of the security protection of the original document 1a to which “LOW CONFIDENTIAL” is set in any case in which the authority level of the document user 1a indicates “MEDIUM CONFIDENTIAL”, “HIGH CONFIDENTIAL”, or “LOW CONFIDENTIAL”.

The encryption degree setting area 11b is used to set the encryption degree of the area to which the security protection is set when the original document 1a is printed out. In the encryption degree setting area 11b, “STRONG ENCRYPTION” indicating a strong level of an encryption and “WEAK ENCRYPTION” indicating a weak level of the encryption are displayed as selective items.

The disclosure display setting area 11c is used to set whether or not one or more portions, to which the security protection is set in the page area of the original document 1a, is displayed without the encryption.

For example, the original document 1a may include an address, a photo, a medical history, and a like of a person. The document manager 1 indicates an area of the medical history as a portion to be secured, by using a touch pen or a like and drawing a diagonal line on the preview image 3a. Subsequently, the document manager 1 selects “HIGH CONFIDENTIAL”, “STRONG ENCRYPTION”, and “DISCLOSURE DISPLAY: NOT DISCLOSE”. In this case, an area 3e is set as the portion to be secured. Also, the document manager 1 can set a different confidential level for each of the address and the photo.

Based on these confidential settings, the image processing apparatus 100 conducts an encryption process corresponding to “STRONG ENCRYPTION” with respect to the area 3e. Accordingly, a secured preview image 3b is displayed at the display part 111. The document manager 1 stores setting information to the image processing apparatus 100 after confirming a security state of the preview image 3b.

When the document user 2 prints out the image of the original document 1a by the image processing apparatus 100, the secured image 3b is displayed at the display part 111.

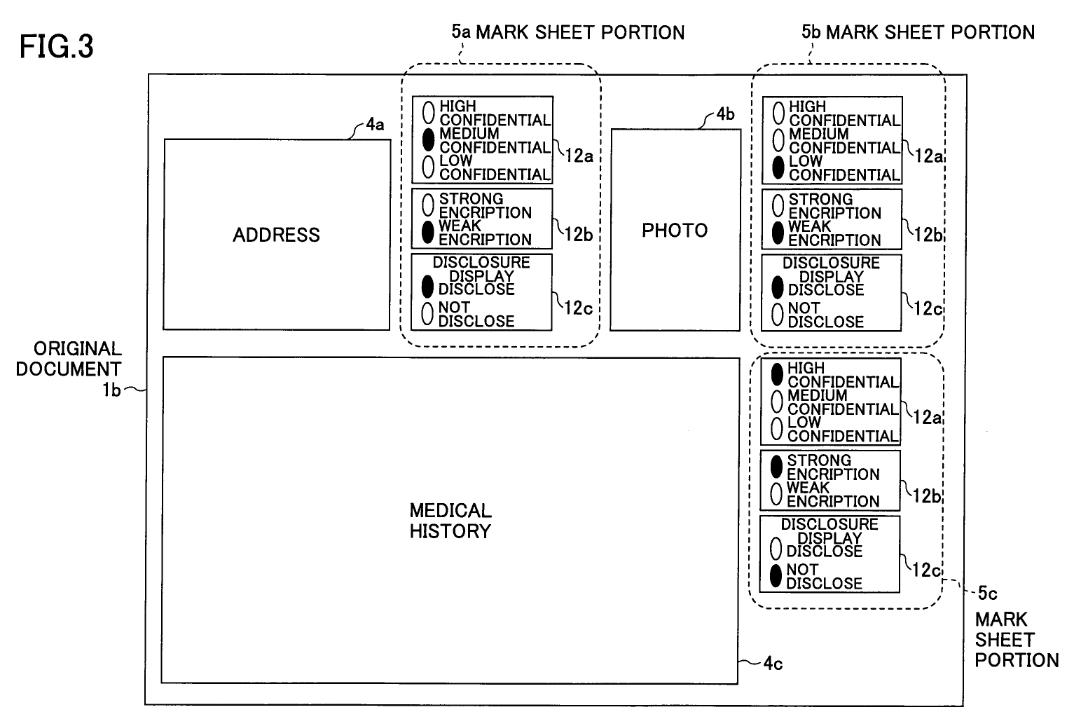

FIG. 3 is a diagram illustrating another example of the confidential level settings for the security protection, according to the embodiment of the present invention. In an original document 1b as a paper document shown in FIG. 3, corresponding to respective areas 4a, 4b, and 4c, mark sheet portions 5a, 5b, and 5c are arranged. The mark sheet portions 5a, 5b, and 5c are formed by a confidential level setting area 12a, an encryption level setting area 12b, and a disclosure display setting area 12c as mark sheets corresponding to the confidential level setting area 11a, the encryption degree setting area 11b, and the disclosure display setting area 11c, respectively.

The document manager 1 marks checked areas for desired items in the mark sheet portions 5a through 5c of the original document 1b, and scans the original document 1b by the image processing apparatus 100. The image processing apparatus 100 generates image data of the original document 1b and also generates confidential level setting information based on marks on the mark sheet portions 5a, 5b, and 5c. The image processing apparatus 100 stores the image data and the confidential level setting information in a predetermined storage area. When the original document 1b is output as the printed document 2a, an image formation is conducted so that the security protection is formed in accordance with the confidential level setting information, and the printed document 2a is output.

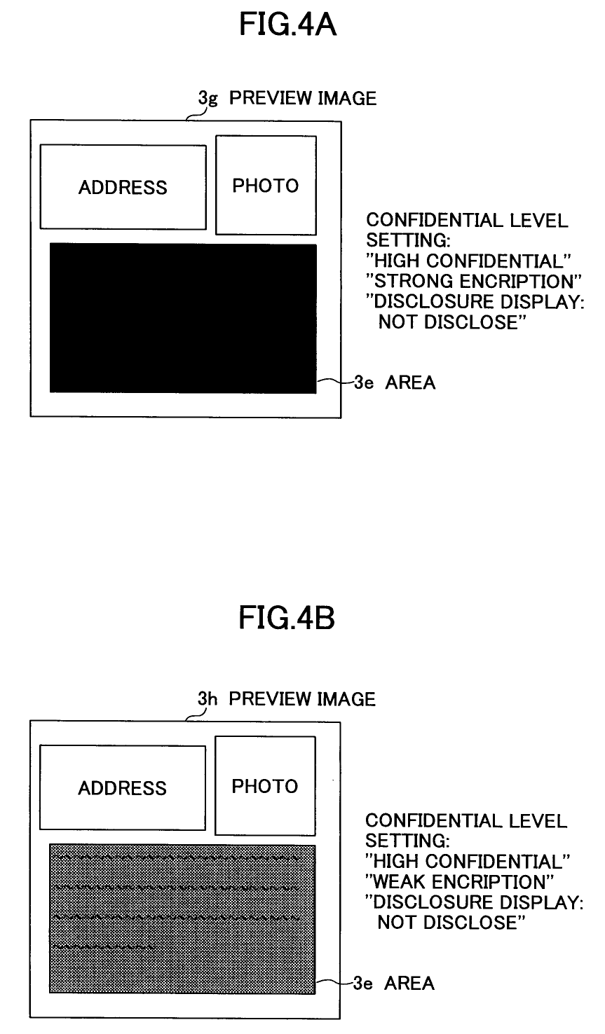

A different output is conducted by a different encryption degree. Different outputs are illustrated in FIG. 4A and FIG. 4B. The different outputs in FIG. 4A and FIG. 4B show the original document 1a being previewed at the display part 111 or a print state of the printed document 2a output from the image processing apparatus 100. For the sake of convenience, a case of the original document 1a being previewed at the display part 111 will be described.

FIG. 4A is a diagram showing an output in a case in which the strong encryption is set as the encryption degree according to the embodiment of the present invention. In a preview image 3g shown in FIG. 4A, when the confidential level settings indicate “HIGH CONFIDENTIAL”, “STRONG ENCRIPTION”, and “DISCLOSURE DISPLAY: NOT DISCLOSE”, the area 3e for the “MEDICAL HISTORY” in the original document 1a is painted with a dark color (or black) and is displayed at the display part 111. In this case, it is difficult to determine whether or not there are contents in the area 3e. It is noted that the printed document 2a is output in a situation as the preview image 3g.

FIG. 4B is a diagram showing another output in a case the low encryption is set as the encryption degree according to the embodiment of the present invention. In a preview image 3h shown in FIG. 4B, the confidential level settings indicate “HIGH CONFIDENTIAL”, “WEAK ENCRIPTION”, and “DISCLOSURE DISPLAY: NOT DISCLOSE”, the area 3e for the “MEDICAL HISTORY” in the original document 1a is painted with a light color (or gray) and is displayed at the display part 111. If there are contents in the area 3e, the contents in the area 3e are encrypted so that it becomes difficult to read contents. Accordingly, in this case, it is difficult to read contents but it is possible to visually recognize whether or not there contents in the area 3e.

As technologies for disclosing contents which are encrypted to be unreadable, it is possible to apply Japanese Laid-open Patent Application No. 2004-40233 disclosing that noises are superimposed to binary image data, Japanese Laid-open Patent Application No. 8-256321 disclosing that a portion in a bit sequence of image data is replaced with another value.

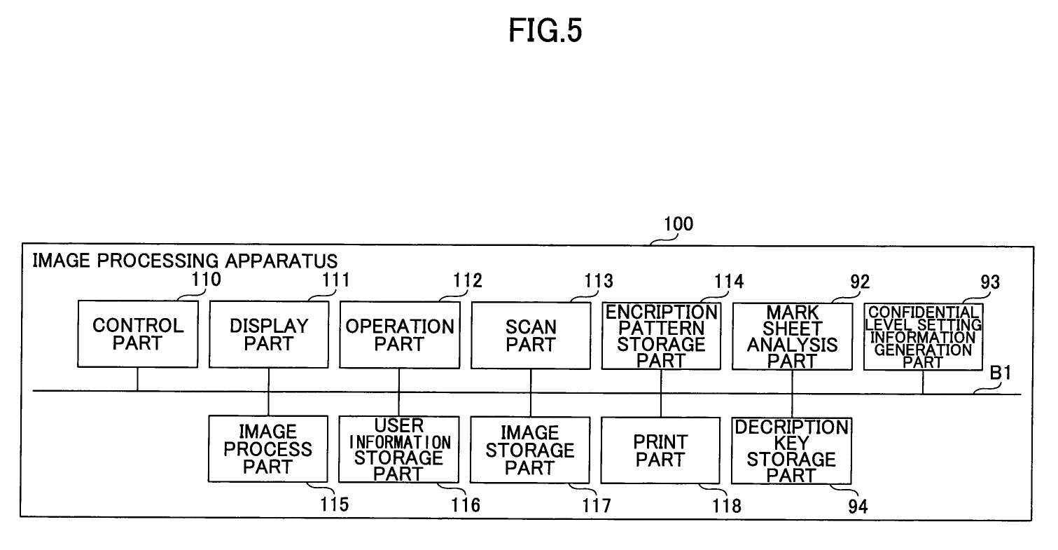

A configuration of the image processing apparatus 100, in which the confidential level settings as described above are allowed and the printed document 2a being secured is output, will be described with reference to FIG. 5. FIG. 5 is a diagram showing the configuration of the image processing apparatus according to the embodiment of the present invention. In FIG. 5, the image processing apparatus 100 includes a control part 110, a display part 111, an operation part 112, a scan part 113, an encryption pattern storage part 114, an image process part 115, a user information storage part 116, an image storage part 117, a print part 118, a mark sheet analysis part 92, a confidential level setting information generation part 93, and a description key storage part 94, which are mutually connected via a bus B1.

The control part 110 includes a CPU (Central Processing Unit) and a memory, and controls the entire image processing apparatus 100. The display part 111 includes a touch panel to display information to a user and to allow the user to input and set information by operating on the touch panel with a touch pen or a finger. The operation part 112 includes a ten-key button, a start button, and a like, and allows the user to operate the image processing apparatus 100 by pressing buttons.

The scan part 113 scans the original document 1a or the original document 1b set by the user. The encryption pattern storage part 114 stores an encryption pattern corresponding to the encryption degree set by the document manager 1.

The image process part 115 conducts various image processes with respect to image data which the scan part 113 generates by scanning the original document 1a or the original document 1b. The user information storage part 116 stores user authentication information such as a password and information indicating the confidential degree used when the document user 2 prints or displays the image data of the original document 1a or the original document 1b for each document user 2, by corresponding the user authentication information to the confidential degree of the document user 2.

The image storage part 117 stores the image data which the scan part 113 generates by scanning the original document 1a or the original document 1b with the confidential level setting information set by the document manager 1, in a storage area. The print part 118 forms an image of the original document 1a or the original document 1b on a sheet and outputs the printed document 2a from the image processing apparatus 100.

The mark sheet analysis part 92 analyzes the mark sheet portions 5a through 5c of the original document 1b scanned by the scan part 113 as shown in FIG. 3. The confidential level setting information generation part 93 generates the confidential level setting information based on the confidential level settings which are analyzed by the mark sheet analysis part 92, and stores the image data of the original document 1b by corresponding to an image ID assigned to the image data, to the image storage part 117. The decryption key storage part 94 stores a key (decryption key) which is used to decrypt the area being encrypted when the image data (document) being accumulated in the image storage part 117 are previewed at the display part 111 or is printed out.

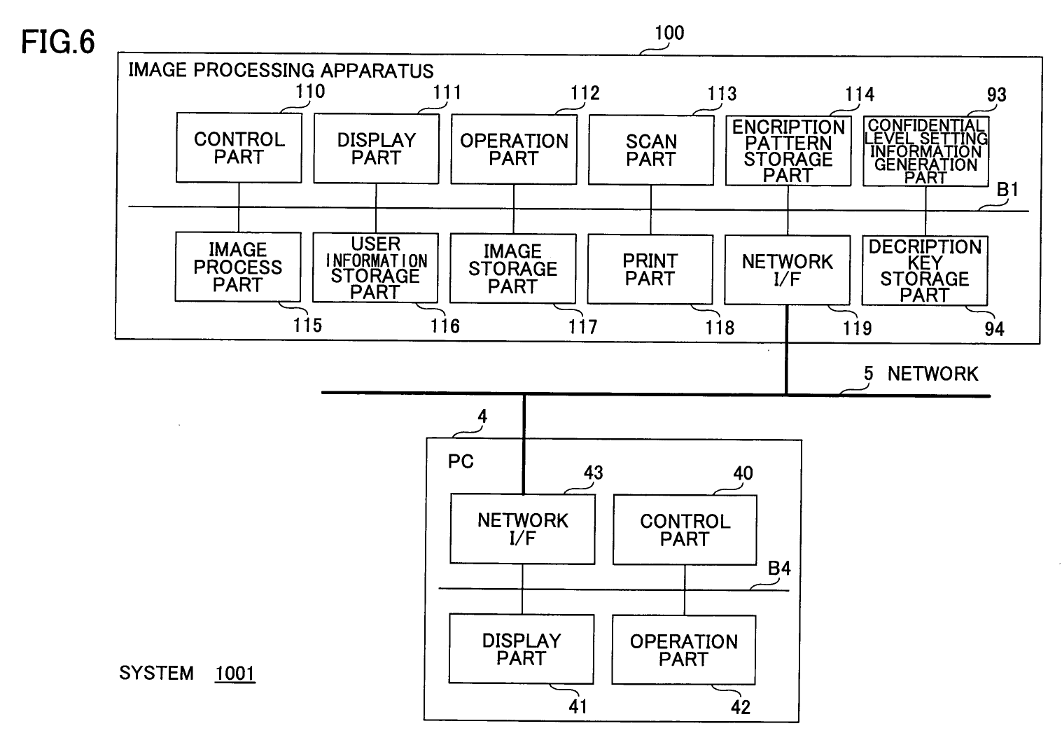

FIG. 6 is a diagram showing a system configuration formed by the image processing apparatus and a PC, according to the embodiment of the present invention. In a system 1001 shown in FIG. 6, the image processing apparatus 100 includes a network I/F (Interface) 119 for a network communication in addition to the configuration shown in FIG. 5, and is connected to a PC (Personal Computer) 4 through a network 5. It is noted that in the system 1001 in FIG. 6, the mark sheet analysis part 92 can be omitted.

The PC 4 includes a control part 40 having a CPU and a memory, a display part 41, an operation part 42 including a mouse, a key board, and a like, and a network I/F 43 for controlling the network communication, which are mutually connected via a bus B4.

In the system 1001 shown in FIG. 6, the document user 2 can access the image processing apparatus 100 by using the PC 4. When the document user 2 selects the image data of the original document 1a stored in the image storage part 117 of the image processing apparatus 100, the preview image 3g or 3h shown in FIG. 4A or FIG. 4B is displayed at the display part 41.

Similarly, the document manager 1 can accesses the image processing apparatus 100 from the PC 4. Also, instead of scanning the original document 1a, the document manager 1 can transmit document data to the image processing apparatus 100 through a network 5, complete the confidential level settings by using the PC 4, and store the document data as the image data in the image storage part 117.

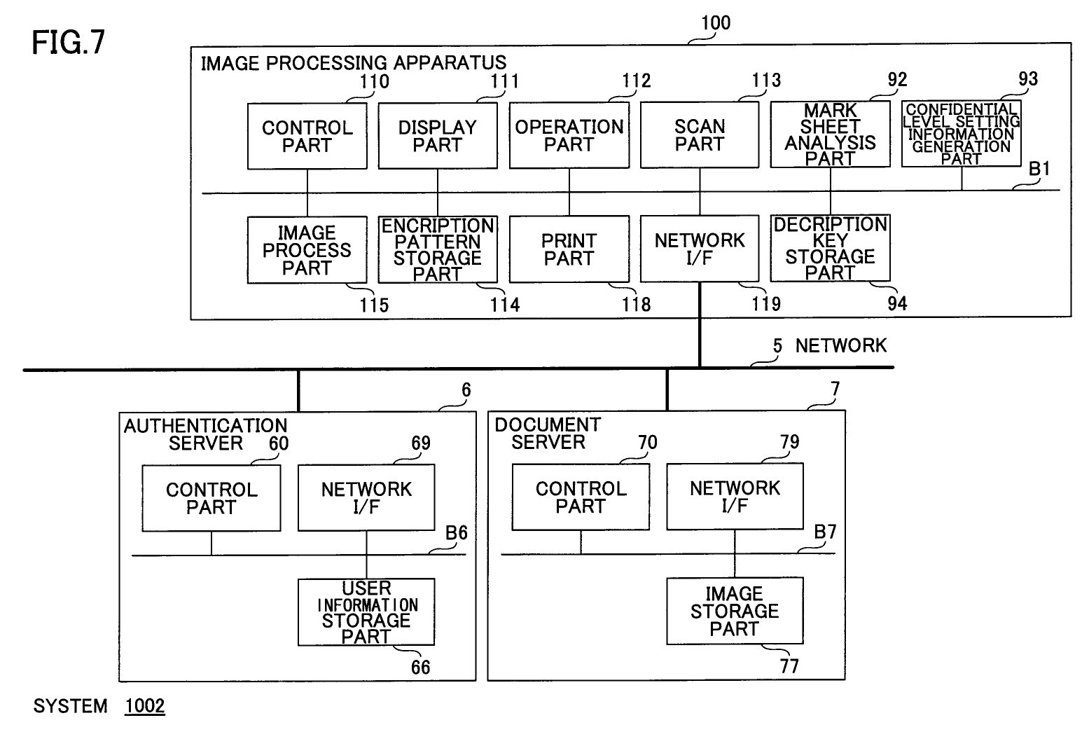

FIG. 7 is a diagram showing a system configuration formed by the image processing apparatus, an authentication server, and a document server, according to the embodiment of the present invention. In a system 1002 shown in FIG. 7, the image processing apparatus 100, a user authentication server 6 for authenticating a user, and a document server 7 for maintaining document data are mutually connected through the network 5.

The image processing apparatus 100 has the configuration shown in FIG. 5 excluding the user information storage part 116 and the image storage part 117. The image processing apparatus 100 conducts a user authentication by using user authentication information maintained by the authentication server 6, and stores the image data of the original document 1a scanned by the scan part 113 to the image storage part 77 of the document server 7.

In the system 1002 shown in FIG. 7, the PC 4 in FIG. 6 may be connected through the network 5.

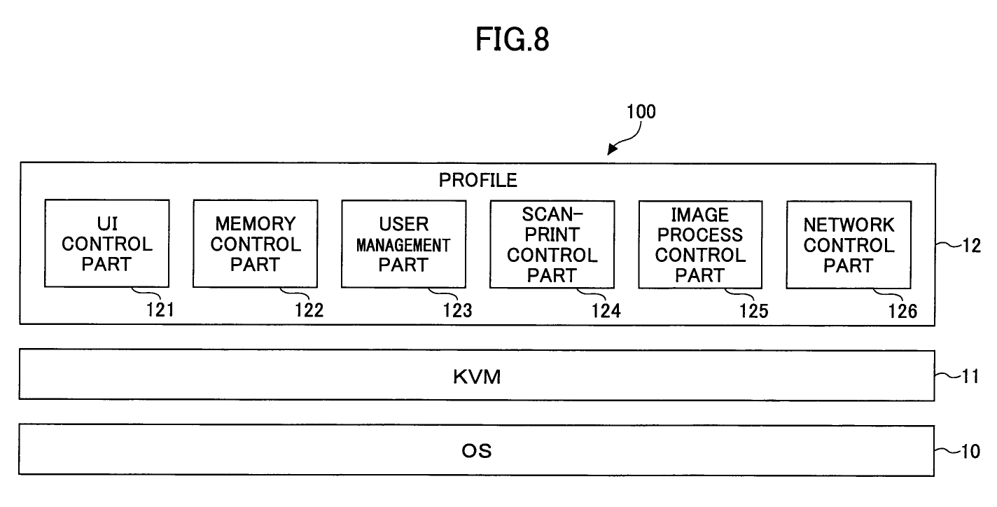

FIG. 8 is a diagram showing a functional configuration of the image processing apparatus shown in FIG. 6, according to the embodiment of the present invention. In FIG. 8, the image processing apparatus 100 includes an OS (Operating System) 10 such as UNIX™, a Java™ virtual machine (KVM: K Virtual Machine) 11 for interpreting and executing Java™, and a Profile 12 used in Java™.

The Profile 12 is developed by Java™, and is formed by a plurality of process parts (modules). The Profile 12 includes a UI control part 121, a memory control part 122, a user management part 123, a scan-print control part 124, an image process control part 125, and a network control part 126.

The UI control part 121 is a process part for displaying information at the display part 111 and performing a process corresponding to a user operation conducted at the operation part 112. The memory control part 122 is a process part for controlling the image storage part 117.

The user management part 123 is a process part for conducting the user authentication by referring to the user information storage part 116. The scan-print control part 124 controls the scan part 113 to scan the original document 1a, and controls the print part 118 to form an image read from the original document 1a on a sheet.

The image process control part 125 is a process part for performing an image process which includes an encryption process conducted in accordance with the confidential level settings of the original document 1a, with respect to the image data of the original document 1a. The network control part 126 is a process part for performing the network communication by controlling the network I/F 119.

Similarly, the image processing apparatus 100 shown in FIG. 6 includes the process parts 121 through 126. In the configuration of the image processing apparatus 100 shown in FIG. 5, the process parts 121 through 125 are included but the network control part 126 is omitted.

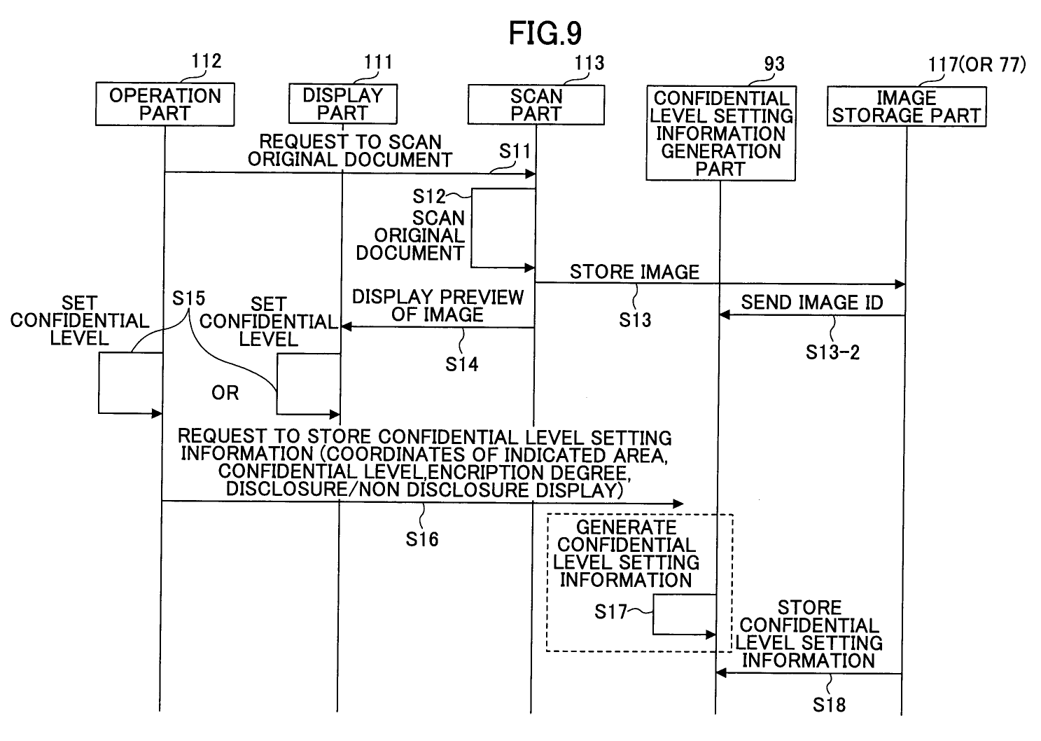

Next, various process sequences will be described with reference to FIG. 9 through FIG. 11. First, a process sequence in a case in that the document manager 1 refers to the preview at the display part 111 and operates the confidential level settings will be described with reference to FIG. 9. FIG. 9 is a diagram showing the process sequence in a case in that the confidential level settings are performed when the original document 1a or 1b is scanned, according to the embodiment of the present invention. The process sequence for the confidential level settings can be similarly conducted in the image process apparatus 100 in FIG. 5, the system 1001 in FIG. 6, and the system 1002 in FIG. 7. Thus, process parts shown in FIG. 9 are denoted by the same numerals as the process parts of the image processing apparatus 100 shown in FIG. 5 and FIG. 6, and a numeral of the process part in the system 1002 in FIG. 7 is indicated in parentheses ( ). In the system 1002, the image data are stored in the image storage part 77 of the document server 7.

In FIG. 9, the operation part 112 sends a request to scan the original document 1a in response to an operation of the document manager 1, to the scan part 113 (step S11). The scan part 113 scans the original document 1a (step S12), and sends and stores image data, which is generated by scanning the document manager 1, to the image storage part 117 (or 77) (step S13). The image storage part 117 (or 77) adds an image ID to the image data received from the scan part 113 and stores the image data in a storage area. After that, The image storage part 117 (or 77) sends the image ID to the confidential level setting information generation part 93 (step S13-2). The image data of the original document 1a are transmitted from the scan part 113 to the display part 111 to display a preview image based on the image data (step S14).

The document manager 1 conducts the confidential level settings by using the preview image from the operation part 112 or the display part 111 (step S15). The operation part 112 or the display part 111 sends a request to store confidential level setting information which indicates the confidential level settings input by the document manager 1, to the confidential level setting information generation part 93 (step S16).

Each confidential level setting indicates coordinates of an indicated area, a confidential level, an encryption degree, a disclosure/non disclosure display. The request to store confidential level setting information includes information indicating coordinates of an indicated area, a confidential level, an encryption degree, a disclosure/non disclosure display for each confidential level setting. The confidential level setting information generation part 93 generates the confidential level setting information additionally including the image ID received from the image storage part 117 (or 77) in the step S13-2 in a predetermined data structure, by using information included in the request to store the confidential level setting information (step S17), and stores the generated confidential level setting information to the image storage part 117 (or 77) (step S18).

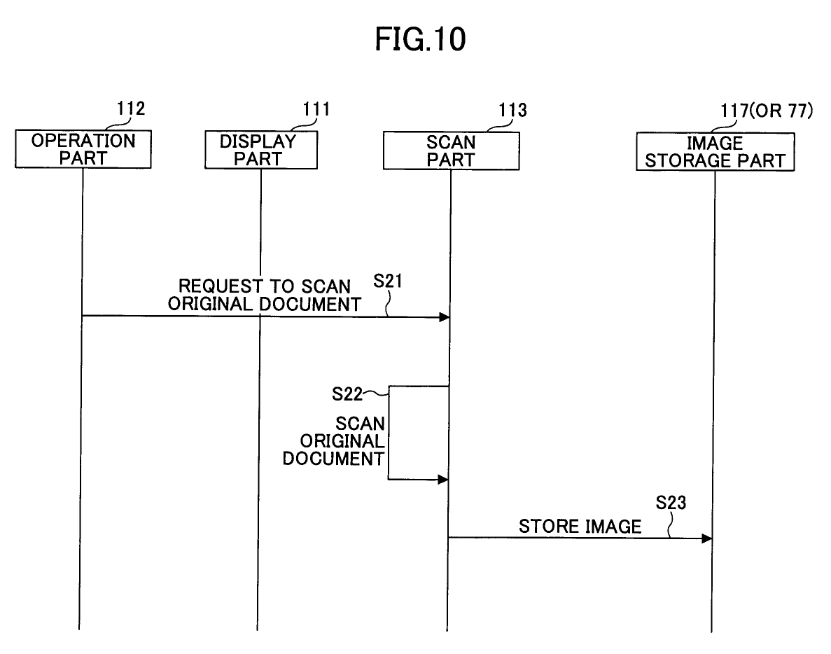

A process sequence will be described with reference to FIG. 10 to scan the original document 1a in a case in that the confidential level setting is determined beforehand due to a fixed format of the original document 1a. FIG. 10 is a diagram showing a process sequence in a case in that the confidential level setting is determined beforehand, according to the embodiment of the present invention. Process parts shown in FIG. 10 are denoted by the same numerals as the process parts of the image processing apparatus 100 shown in FIG. 5 and FIG. 6, and a numeral of the process part in the system 1002 in FIG. 7 is indicated in parentheses ( ). In the system 1002, the image data are stored in the image storage part 77 of the document server 7.

In FIG. 10, the operation part 112 sends a request to scan the original document 1a to the scan part 113, in response to an operation of the document manager 1 (step S21). The scan part 113 scans the original document 1a (step S22), and stores an image generated by scanning the original document 1a to the image storage part 117 (or 77) (step s23).

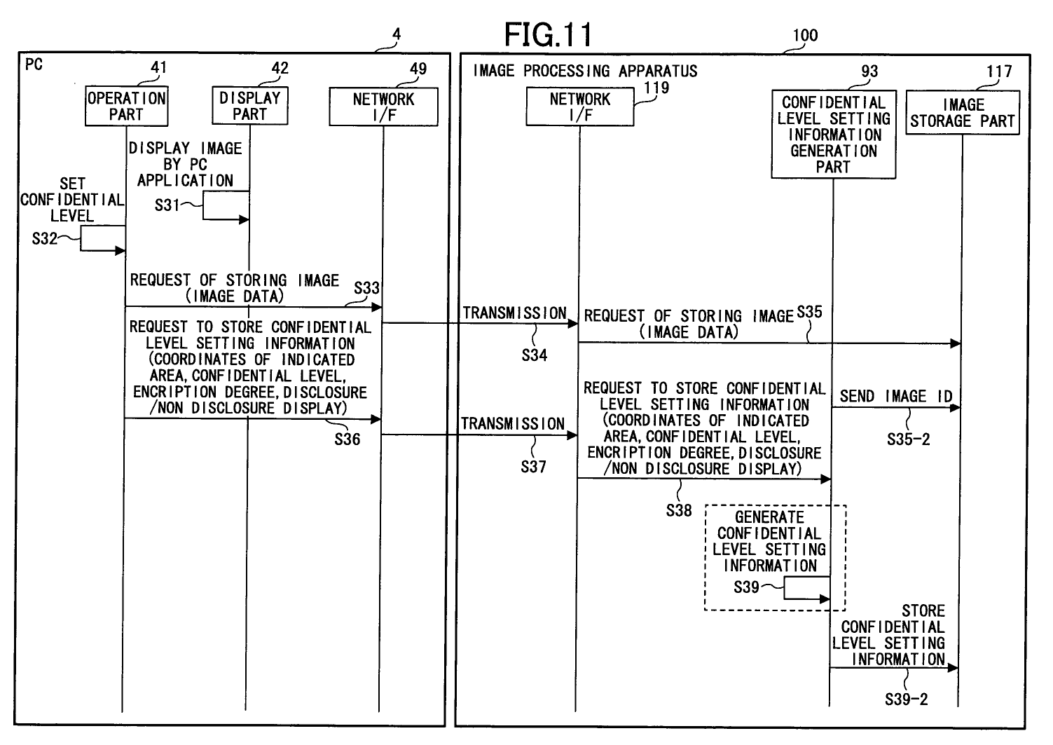

FIG. 11 is a diagram for explaining a process sequence in a case in that the document manager 1 conducts the confidential level setting from the PC 4, according to the embodiment of the present invention. In FIG. 11, the document manager 1 displays the image of the original document 1a on a PC application (step S31), and conducts the confidential level setting by operating the operation part 41 (step S32).

After that, when the document manager 1 attempts to store the image by operating the operation part 41, a request including image data to store the image of the original document 1a is sent to the network I/F 49 from the operation part 41 (step S33). The network I/F 49 transmits the request to store the image to the image processing apparatus 100 (step S34).

In the image processing apparatus 100, the network I/F 119 receives the request including the image data to store the image of the original document 1a, and sends the request to the image storage part 117 (step S35). The image storage part 117 additionally includes the image ID in the image data received from PC 4, stores the image data in a storage area, and sends the image ID to the confidential level setting information generation part 93 (step S35-2).

Also, at the PC 4, the operation part 41 sends a request to store confidential level setting information, to the network I/F 49 (step S36). The request to store confidential level setting information includes information indicating coordinates of an indicated area, a confidential level, an encryption degree, and a disclosure/non disclosure display for each confidential level setting. The network I/F 49 transmits the request to store confidential level setting information includes information, to the image processing apparatus 100 (step S37).

At the image processing apparatus 100, when the network I/F 119 receives the request to store the confidential level setting information, the network I/F 119 sends the request to the confidential level setting information generation part 93 (step S38). The confidential level setting information generation part 93 generates the confidential level setting information additionally including the image ID received from the image storage part 117 in the step S35-2, in accordance with a predetermined data structure by using the information included in the request to store the confidential level setting information (step S39), and stores the confidential level setting information to the image storage part 117 (step S39-2).

In a case in that the PC 4 stores the image data and the confidential level setting information to the document server 7, the image processing apparatus 100 is replaced with the document server 7 in FIG. 11. The image data and the confidential level setting information are stored in the image storage part 77. A process sequence in this case is the same as the above-described process sequence.

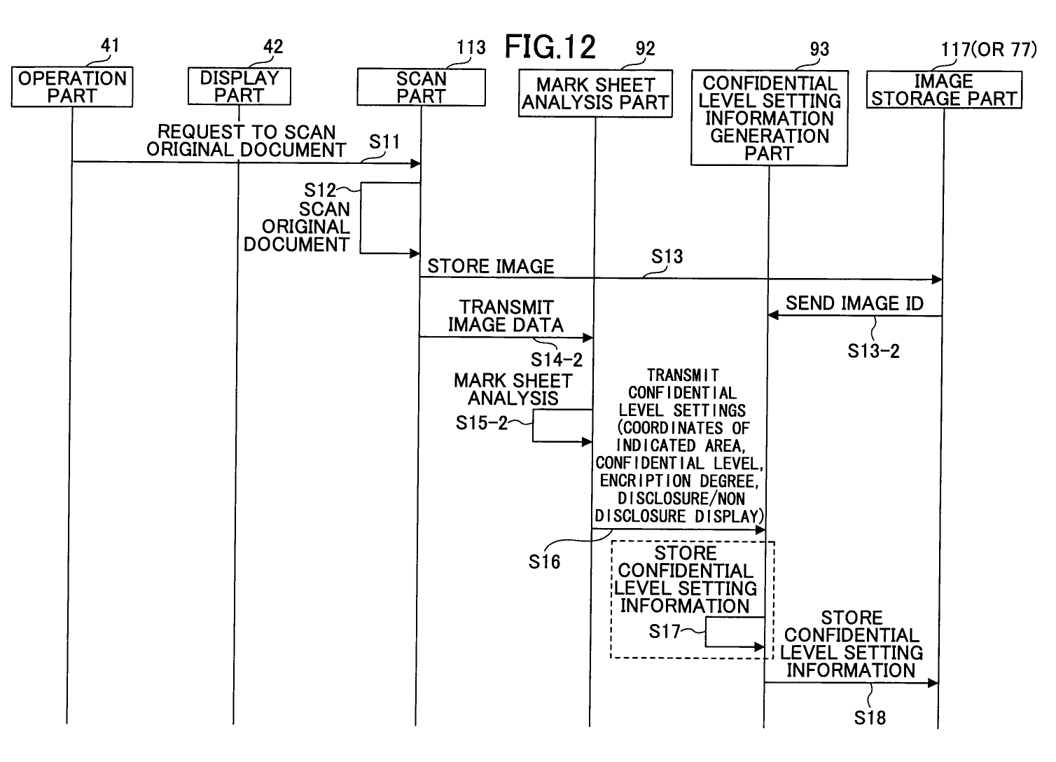

FIG. 12 is a diagram showing a process sequence in a case in that the mark sheet portions 5a through 5c are analyzed by the original document 1b shown in FIG. 3 and the confidential level setting is determined, according to the embodiment of the present invention. In FIG. 12, steps that are the same as the ones in FIG. 9 are indicated by the same reference numerals and the explanation thereof will be omitted. In FIG. 12, when the original document 1b is scanned and the image data of the original document 1b is stored in the predetermined storage area (step S11 through S13-2), the scan part 13 sends the image data to the mark sheet analysis part 92 (step S14-2).

The mark sheet analysis part 92 specifies coordinates defining each of the areas 4a through 4c from the image data, and sends the confidential level setting acquired by analyzing marked portions in the mark sheet portions 5a through 5c for each of the areas 4a through 4c, to the confidential level setting information generation part 93 (step S93).

For each of the areas 4a through 4c, the confidential level setting sent to the confidential level setting information generation part 93 indicates coordinates, a confidential level, an encryption degree, and a disclosure/non disclosure display. The confidential level setting information generation part 93 generates the confidential level setting information additionally including the image ID received from the image storage part 117 (or 77) in the step S13-2 by using values of the confidential level setting received from the mark sheet analysis part 92 (step S17), and stores the confidential level setting information to the image storage part 117 (or 77) (step S18).

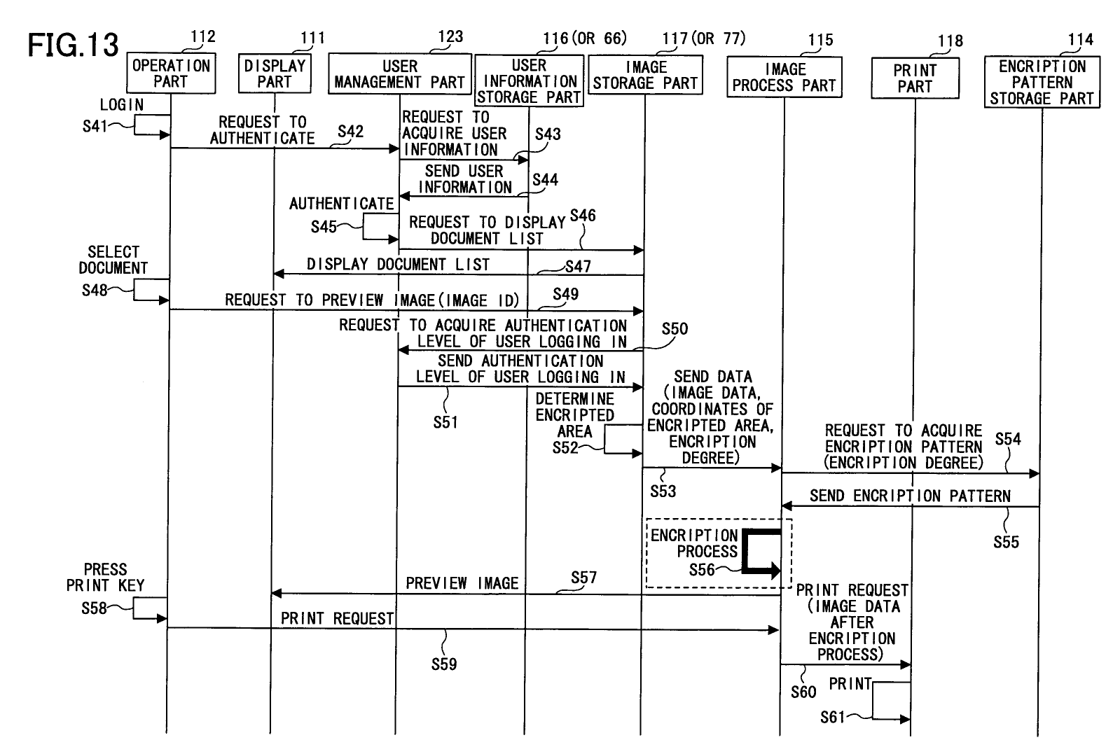

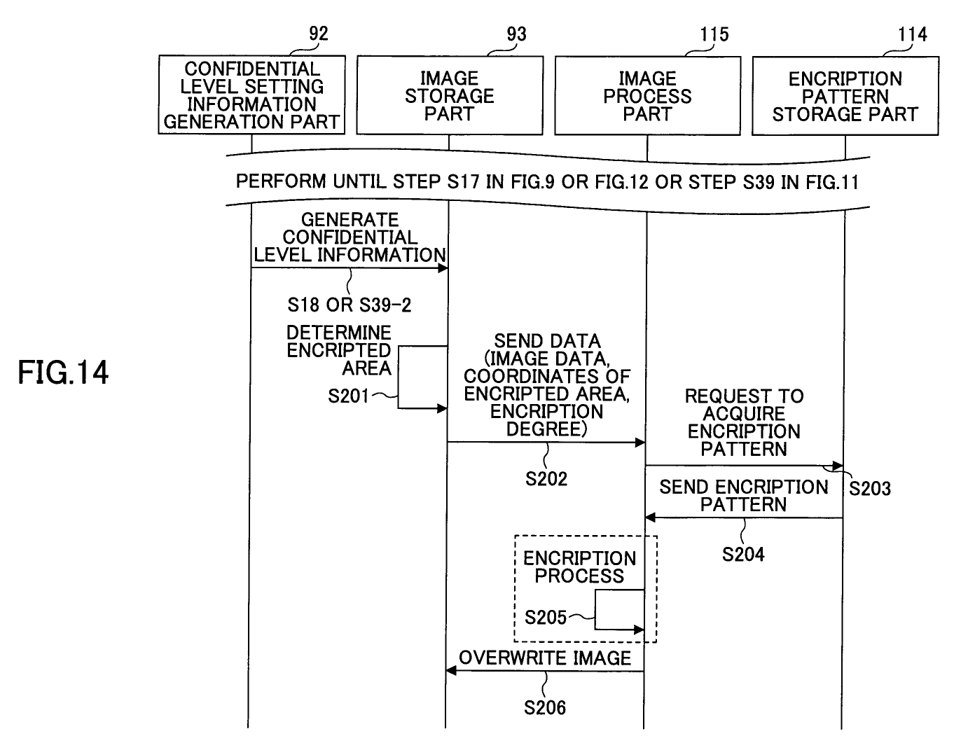

A case of encrypting portions of the image data by using an encryption pattern determined based on the encryption degree indicated in the confidential level setting information and the authentication level of the document user 1 and displaying a preview image of the original document 1a (or 1b) will be described with reference to FIG. 13.

FIG. 13 is a diagram showing a process sequence for previewing an image being partially encrypted based on the authentication level, according to the embodiment of the present invention. In FIG. 13, in a case in that the user authentication is conducted by the image processing apparatus 100, the user information storage part 116 of the image processing apparatus 100 is used. Alternatively, in a case of the system 1002 providing the authentication server 6, the user information storage part 66 of the authentication server 6 is used. Similarly, in a case of storing the image of the original document 1a scanned by the image processing apparatus 100, the image storage part 117 of the image processing apparatus 100 is used. Alternatively, in a case of the system 1002 providing the document server 7, the image is stored to the image storage part 77 of the document server 7. In any case, since the process sequence is similarly conducted, process parts shown in FIG. 13 are denoted by the same numerals as the process parts of the image processing apparatus 100 shown in FIG. 5 and FIG. 6, and a numeral of the process part in the system 1002 in FIG. 7 is indicated in parentheses ( ).

In FIG. 13, when the document user 2 logs in by using the operation part 112 (step S41), the operation part 112 sends an authentication request including authentication information such as a user name and password to the user management part 123 (step S42). In the step S41, instead of a login from the operation part 112, the document user 2 may use a card reader to read a card recording the user name and the password in order to log in.

The user management part 123 sends a request including the authentication information to acquire user information, to the user information storage part 116 (or 66) (step S43). The user information storage part 116 (or 66) sends user information including the password and the like corresponding to the user name, to the user management part 123 (step S44). The user management part 123 conducts the user authentication based on the user information received from the user information storage part 116 (or 66) (step S45).

When the user authentication is successful, the user management part 123 sends a request to display a document list with respect to the image storage part 117 (or 77) (step S46). When the user authentication is failed, the user management part 123 instructs the display part 111 to display a screen showing an authentication failure, and does not send the request to display the document list.

In response to the request to display the document list, the image storage part 117 (or 77) instructs the display part 111 to display the document list (step S48).

The document user 2 selects a document from the document list displayed at the display part 111 (step S48). The operation part 112 sends a request including the image ID identifying the selected document to display a preview image, to the image storage part 117 (or 77) (step S49). The image storage part 117 (or 77) reads out the image data and the confidential level setting information corresponding to the image ID from the predetermined storage area.

The image storage part 117 (or 77) sends a request including the user name of the document user 2 to acquire an authentication level, to the user management part 123 (step S50). The user management part 123 acquires the authentication level of the document user 2 as a user currently logging in, from the user information acquired from the user information storage part 116 (or 66), and sends the authentication level to the image storage part 117 (or 77) (step S51).

When the image storage part 117 (or 77) acquires the authentication level of the document user 2, the image storage part 117 (or 77) determines whether or not each indicated area as a secured range is an area (hereinafter, called an encryption area) to be actually encrypted in the image data corresponding to the image ID, by comparing the authentication level with the confidential degree indicated in the confidential degree setting information (step S52), and sends data concerning an encryption to the image process part 115 (step S53). The data sent to the image process part 115 include the image data, coordinates of the encryption area, and the encryption degree.

In order to acquire the encryption pattern, the image process part 115 acquires the encryption degree from the received data, and sends a request indicating the encryption degree to acquire the encryption pattern, to the encryption pattern storage part 114 (step S54). The encryption pattern storage part 114 sends the encryption pattern corresponding to the encryption degree indicated in the request received to acquire the encryption pattern, to the image process part 115 (step S55).

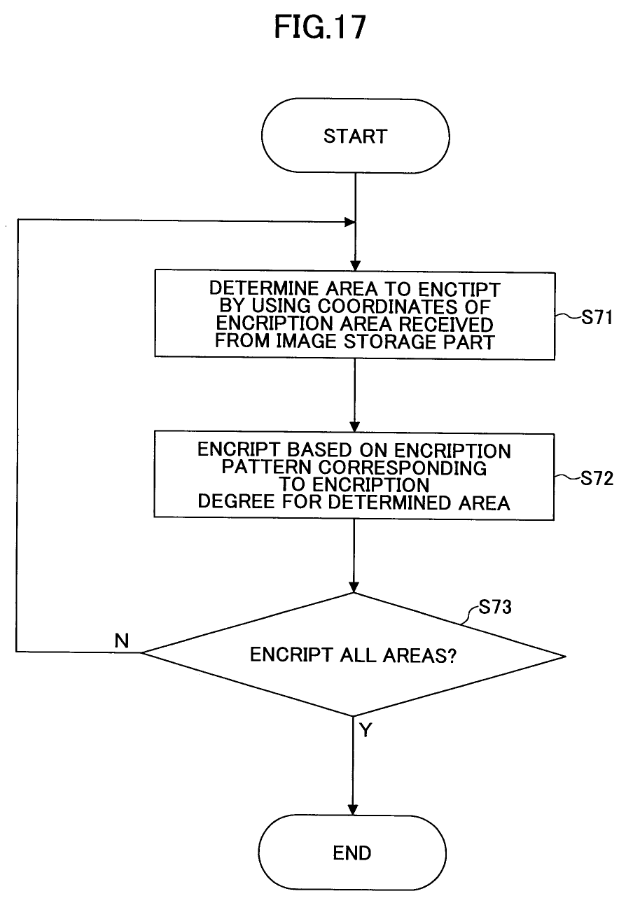

The image process part 115 performs an encryption process with respect to the encryption area by using the encryption pattern received from the encryption pattern storage part 114 (step S56). The encryption process will be described with reference to FIG. 17 in detail.

The image process part 115 instructs the display part 111 to display a preview image by using the image data being partially encrypted (step S57). After the document user 2 confirms the preview image displayed at the display part 111, the document user 2 presses a print key of the operation part 112 (step S58). The operation part 112 sends a print request to the image process part 115 (step S59).

In order to print out, the image process part 115 sends a print request including the image data being partially encrypted, to the image print part 118 (step S60). Thus, the image print part 118 conducts the print process (step S61).

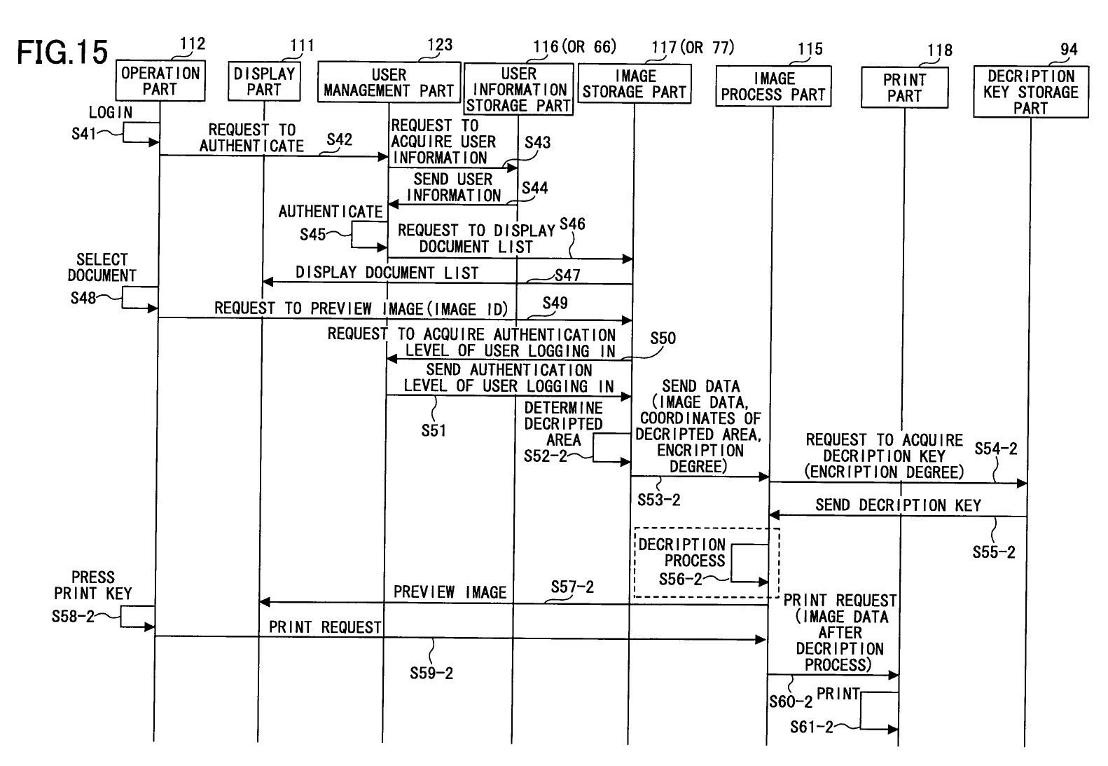

Next, a process sequence for encrypting a confidential area in the original document 1a or the original document 1b and storing the image data will be described with reference to FIG. 14. FIG. 14 is a diagram for explaining the process sequence for encrypting a confidential area in the original document and storing the image data, according to the embodiment of the present invention.

In FIG. 14, after the steps S11 through S17 in FIG. 9 and FIG. 12 or the steps S31 through S39 in FIG. 11 are executed and the confidential level setting information additionally including the image ID is stored in the predetermined storage area (the step S18 in FIG. 9 and FIG. 12 or the step S39-2 in FIG. 11), the image storage part 93 determines the encryption area by using the confidential level setting information (step S201), and acquires the encryption degree and the coordinates of the encryption area. The image storage part 93 sends the image data, the coordinates of the encryption area, and data including the encryption degree to the image process part 115 (step S202).

The image process part 115 acquires the encryption degree from the data received from the image storage part 93, sends a request to acquire the encryption pattern corresponding to the encryption degree with respect to the encryption pattern storage part 114 (step S203). The encryption pattern storage part 114 sends the encryption pattern corresponding to the encryption degree to the image process part 115 (step S204).

The image process part 115 performs the encryption process for encrypting one or more portions in the image data by using the coordinates of the encryption area and the encryption pattern received from the encryption pattern storage part 114 (step S205). Then, the image process part 115 instructs the image storage part 93 to overwrite the image data, which are currently stored and correspond to the image ID informed from the image storage part 117 (or 77), with the encrypted image data in which one or more portions are encrypted (step S206).

A case, in which one or more encrypted portions in the image data are decrypted by a decryption key corresponding to the encryption degree indicated in the confidential level setting information and the authentication level of the document user 2 and the preview image is displayed by using the decrypted image data, will be described with reference to FIG. 15.

FIG. 15 is a diagram for explaining the process sequence for displaying the preview image based on the image data in which one or more portions are decrypted by corresponding to the authentication level, according to the embodiment of the present invention. In FIG. 15, in a case in that the user authentication is conducted by the image processing apparatus 100, the user information storage part 116 of the image processing apparatus 100 is used. Alternatively, in a case of the system 1002 providing the authentication server 6, the user information storage part 66 of the authentication server 6 is used. Similarly, in a case of storing the image of the original document 1a or the original document 1b scanned by the image processing apparatus 100, the image storage part 117 of the image processing apparatus 100 is used. Alternatively, in a case of the system 1002 providing the document server 7, the image is stored to the image storage part 77 of the document server 7. In any case, since the process sequence is similarly conducted, process parts shown in FIG. 13 are denoted by the same numerals as the process parts of the image processing apparatus 100 shown in FIG. 5 and FIG. 6, and a numeral of the process part in the system 1002 in FIG. 7 is indicated in parentheses ( ) in FIG. 15. Furthermore, steps that are the same as the ones in FIG. 13 are indicated by the same reference numerals and the explanation thereof will be omitted.

After the steps S41 through S51 are executed, when the image storage part 117 (or 77) acquires the authentication level from the user management part 123, the image storage part 117 (or 77) determines whether or not each indicated area as a secured range is an area (hereinafter, called a decryption area) allowed to actually decrypt in the image data corresponding to the image ID, by comparing the authentication level with the confidential degree indicated in the confidential degree setting information (step S52-2), and sends data concerning a decryption to the image process part 115 (step S53-2). The data sent to the image process part 115 include the image data, coordinates of the decryption area, and the encryption degree.

In order to acquire the decryption key, the image process part 115 acquires the encryption degree from the received data, and sends a request indicating the encryption degree to acquire the decryption key, to the decryption key storage part 94 (step S54-2). The decryption key storage part 94 sends the decryption key corresponding to the encryption degree indicated in the request received to acquire the decryption key, to the image process part 115 (step S55-2).

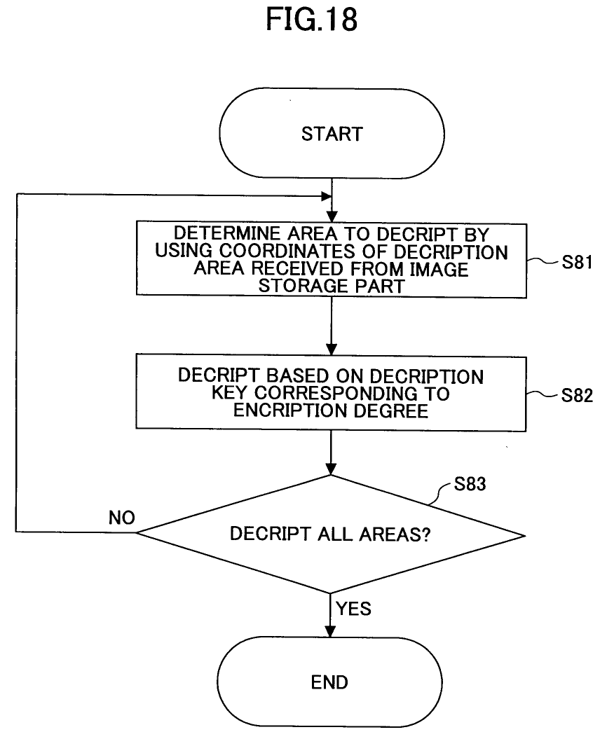

The image process part 115 performs a decryption process with respect to the decryption area by using the decryption key received from the decryption key storage part 94 (step S56-2). The decryption process will be described with reference to FIG. 18 in detail. After the decryption process, the image data may include an area being decrypted and another area being encrypted without being decrypted, based on a result from comparing the authentication level of the document user 2 and the confidential degree.

The image process part 115 instructs the display part 111 to display a preview image by using the image data in which the area being a portion of the image data and encrypted is decrypted (step S57-2). After the document user 2 confirms the preview image displayed at the display part 111, the document user 2 presses the print key of the operation part 112 (step S58-2). The operation part 112 sends a print request to the image process part 115 (step S59-2).

In order to print out, the image process part 115 sends a print request including the image data in which the encrypted area being the portion of the image data is decrypted after the decryption process, to the image print part 118 (step S60-2). Thus, the image print part 118 conducts the print process (step S61-2).

Accordingly, as the above-described process sequences in FIG. 14 and FIG. 15, the image data are partially encrypted when the image data are stored in the predetermined storage area, and the encrypted area in the image data is decrypted based on the authentication level of the document user 2 when the image data are printed out.

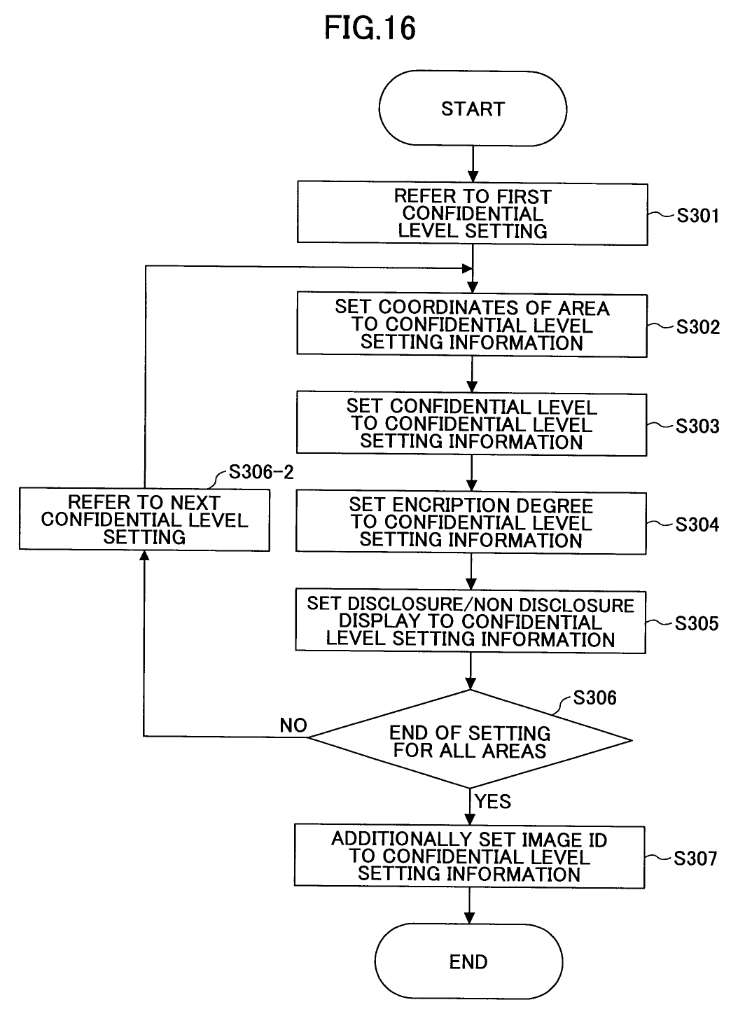

A confidential level setting information generation process, which is conducted by the confidential level setting information generation part 93 in the step S17 in FIG. 9 and FIG. 12 or the step S39 in FIG. 11, will be described with reference to FIG. 16. FIG. 16 is a flowchart for explaining the confidential level information generation process according to the embodiment of the present invention. In FIG. 16, the confidential level setting information generation part 93 refers to a first confidential setting from the request received from the operation part 112 to store the confidential level setting information (step S301). In the following, the first confidential setting will be simply referred to as the confidential level setting.

The confidential level setting information generation part 93 sets the coordinates of the area indicated in the confidential level setting into the confidential level setting information formed in a predetermined data structure (step S302). The confidential level indicated in the confidential level setting is set into the confidential level setting information (step S303). The encryption degree indicated in the confidential level setting is set into the confidential level setting information (step S304). The disclosure/non disclosure display indicated in the confidential level setting is set into the confidential level setting information (step S305).

Subsequently, the confidential level setting information generation part 93 determines whether or not the confidential level setting information generation process is performed for all areas to which the confidential level setting is conducted (step S306). When the confidential level setting information generation process is not performed for all areas, the confidential level setting information generation part 93 refers to a next confidential level setting from the request to store the confidential level setting information (step S306-2), and the above-described steps S302 through S306 are repeated.

On the other hand, when the confidential level setting information generation process is performed for all areas, the confidential level setting information generation part 93 additionally includes the image ID in the confidential level setting information (step S307), and terminates the confidential level setting information generation part.

Next, the encryption process performed by the image process part 115 in the step S56 in FIG. 13 and the step S205 in FIG. 14 will be described with reference to FIG. 17. FIG. 17 is a flowchart for explaining the encryption process according to the embodiment of the present invention. In FIG. 17, the image process part 115 determines the area to be encrypted, by using the coordinates of the encryption area received from the image storage part 117 (or 77) (step S71).

Next, the image process part 115 acquires the encryption pattern corresponding to the encryption degree for the determined area, and encrypts the determined area based on the encryption pattern (step S72).

Accordingly, the image process part 115 determines whether or not all areas informed from the image storage part 117 (or 77) (step S73). When the image process part 115 does not encrypt all areas informed from the image storage part 117 (or 77), the image storage part 117 (or 77) goes back to the step S71 and repeats the above-described steps S71 through S73. When the image process part 115 encrypts all areas informed from the image storage part 117 (or 77), the image process part 115 terminates the encryption process.

Accordingly, it is possible to encrypt each of one or more areas to be secured in a degree in which a presence of the contents may be darkly determined but cannot be readable.

Next, the decryption process, which is performed by the image process part 115 in the step S56-2 in FIG. 18, will be described with reference to FIG. 18. FIG. 18 is a flowchart for explaining the decryption process according to the embodiment of the present invention. In FIG. 18, the image process part 115 determines the area to be decrypted by using the coordinates the decryption area received from the image storage part 117 (or 77) (step S81).

Next, the image process part 115 acquires the decryption key corresponding to the encryption degree of the determined area from the decryption key storage part 94, and decrypts the determined area by using the decryption key (step S82).

Then, the image process part 115 determines whether or not all areas informed from the image storage part 117 (or 77) are encrypted (step S83). When the all areas informed from the image storage part 117 (or 77) are not decrypted, the image process part 115 goes back to the step S81, and repeats the above-described steps S81 through S83. When the all areas informed from the image storage part 117 (or 77) are decrypted, the image storage part 117 (or 77) terminates the decryption process.

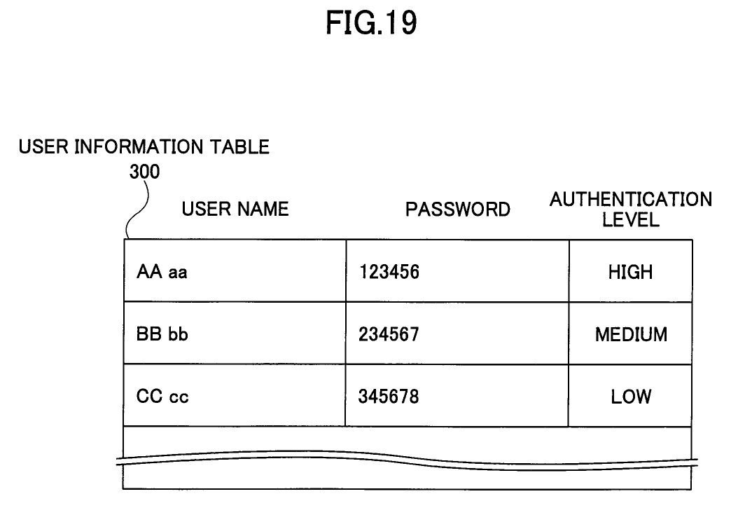

FIG. 19 is a diagram showing a user information table stored in the user information storage part 66 according to the embodiment of the present invention. A user information table 300 shown in FIG. 19 includes items of a user name, a password, an authentication level, and a like.

For example, in the user information table 300 shown in FIG. 19, a password of a user having a user name “AA aa” is “123456”, and the user “AA aa” has a “HIGH” authentication level. Moreover, a password of a user having a user name “BB bb” is “234567”, and the user “BB bb” has a “MEDIUM” authentication level. Furthermore, a password of a user having a user name “CC cc” is “345678”, and the user “CC cc” has a “LOW” authentication level.

In the user information table 300, instead of maintaining the user information for each user, the password and the authentication level are stored and maintained for each division, section, title, or a like.

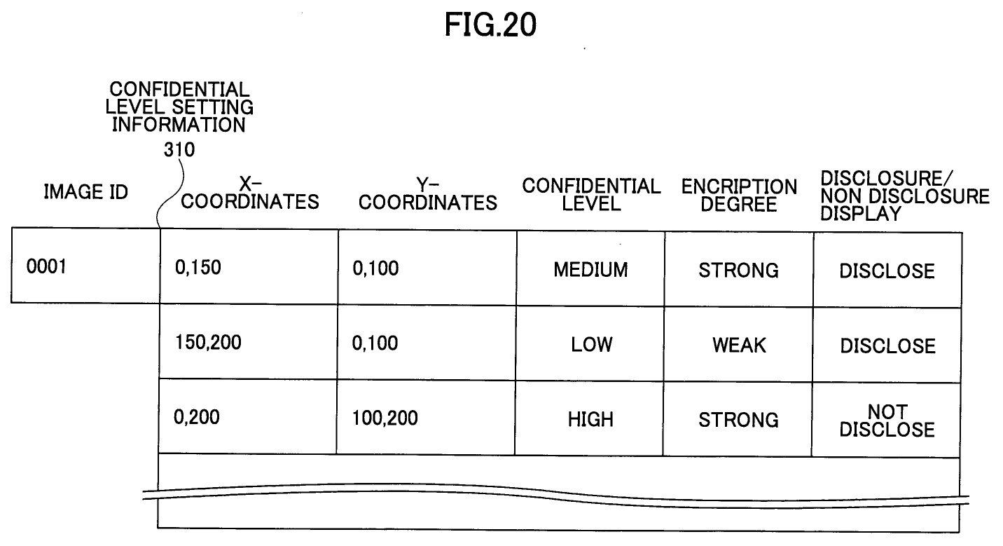

FIG. 20 is a diagram showing the confidential level setting information according to the embodiment of the present invention. In FIG. 20, a confidential level setting information 310 indicates the confidential level setting value for each of one or more ranges to be secured with respect to the image data, and includes items of an image ID, X-coordinates, Y-coordinates, a confidential degree, an encryption degree, a disclosure/nondisclosure display, and a like.

The confidential level setting information 310 shown in FIG. 20 indicates a start point coordinate and an end point coordinate of a diagonal line to specify the range to be secured, by the X-coordinates and the Y-coordinates.

For example, an area defined by the start point coordinate (0,0) and the endpoint coordinate (150,100) based on the X-coordinates “0,150” and the Y-coordinates “0,100” is the range to be secured, the confidential degree is “MEDIUM”, the encryption degree is “STRONG”, and the display part 111 is allowed to disclose the contents of the image data. Moreover, an area defined by the start point coordinate (150,0) and the end point coordinate (200,100) based on the X-coordinates “150,200” and the Y-coordinates “0,100” is the range to be secured, the confidential degree is “LOW”, the encryption degree is “WEAK”, and the display part 111 is allowed to disclose the contents of the image data. Furthermore, an area defined by the start point coordinate (0,100) and the end point coordinate (200,200) based on the X-coordinates “0,200” and the Y-coordinates “100,200” is the range to be secured, the confidential degree is “HIGH”, the encryption degree is “STRONG”, and the display part 111 is not allowed to disclose the contents of the image data.

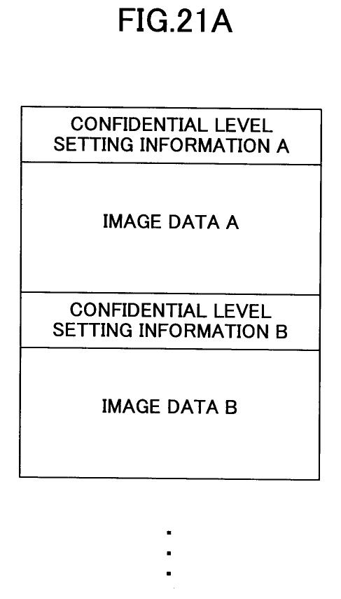

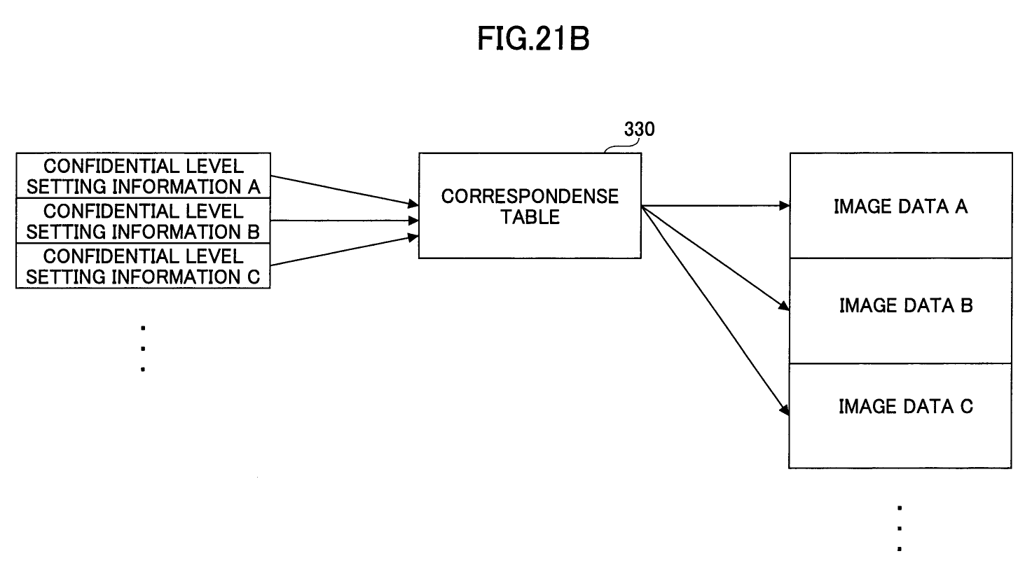

Storage examples of the confidential level setting information will be described with reference to FIG. 21A and FIG. 21B. In FIG. 21A and FIG. 21B, confidential level setting information A is shown as the confidential level setting information 310 for image data A, confidential level setting information B is shown as the confidential level setting information 310 for image data B, and confidential level setting information C is shown as the confidential level setting information 310 for image data C.

FIG. 21A illustrates that the confidential level setting information A, the confidential level setting information B, . . . are stored at beginnings of the image data A, the image data B, . . . , respectively, so as to consecutively store in a sequence of the confidential level setting information A, the image data A, the confidential level setting information B, the image data B, . . . The image data A, the image data B, . . . include respective image IDs, and the confidential level setting information A, the confidential level setting information B . . . include respective image IDs, so that the respective image IDs can make relationships between the image data A and the confidential level setting information A, the image data B and the confidential level setting information B . . .

In FIG. 21B, the confidential level setting information A, the confidential level setting information B, the confidential level setting information C, . . . are collectively stored in the same storage area. Similarly, the image data A, the image data B, the image data C, . . . are collectively stored in the same storage area which is separate from the storage area for the confidential level setting information A, the confidential level setting information B, the confidential level setting information C, . . . The correspondence table 330 maintains relationships between the confidential level setting information A, the confidential level setting information B, the confidential level setting information C, . . . and the image data A, the image data B, the image data C, . . . , respectively. For example, the correspondence table 330 stores the image IDs and pointers of the image data A, the image data B, the image data C, . . . by corresponding to respective image IDs. In this case, the image ID is included at least in each of the confidential level setting information A, the confidential level setting information B, the confidential level setting information C, . . . Alternatively, the correspondence table 330 may store the image IDs and pointers of the confidential level setting information A, the confidential level setting information B, the confidential level setting information C, . . . by corresponding to respective image IDs. In this case, the image ID is included at least in each of the image data A, the image data B, the image data C, . . .

As described above, according to the present invention, it is possible for the document manager 1 to set a plurality of portions in one page of the original document 1a or 1b as ranges to be secured. Moreover, it is possible for the document manager 1 to set the confidential degree for each of ranges to be secured. Furthermore, it is possible for the document manager 1 to set the disclosure/nondisclosure display with respect to the regions to be secured when the image of the original document 1a or 1b is previewed at the display part 111.

The present invention is not limited to the specifically disclosed embodiments, and variations and modifications may be made without departing from the scope of the present invention.

The present application is based on the Japanese Priority Applications No. 2006-182200 filed Jun. 30, 2006 and No. 2007-160921 filed Jun. 19, 2007, the entire contents of which are hereby incorporated by reference.

What is claimed is:

1. An image processing apparatus for scanning and printing out an original document, comprising:
a setting part setting an encryption degree for encrypting contents in a range in the original document to become difficult to visually determine, for each of one or more ranges which are set to partially secure the original document.

2. The image processing apparatus as claimed in claim 1, wherein the setting part sets the one or more ranges to be secured, on a preview image of the original document being displayed.

3. The image processing apparatus as claimed in claim 1, wherein the setting part acquires the one or more regions to be secured, from image data generated by scanning the original document, and acquires the encryption degree by analyzing one or more mark sheet portions which correspond to the one or more regions and include a setting of the encryption degree.

4. The image processing apparatus as claimed in claim 1, wherein the setting part allows setting a confidential level for each of the one or more regions to be secured.

5. The image processing apparatus as claimed in claim 1, wherein the setting part allows setting a disclosure/non disclosure display indicating whether or not the contents is permitted to disclose, for each of the one or more regions to be secured.

6. The image processing apparatus as claimed in claim 1, further comprising an encryption process part conducting an encryption process for partially encrypting image data generated by scanning the original document based on confidential level setting information indicating setting values acquired by the setting part.

7. The image processing apparatus as claimed in claim 6, wherein the image data is stored in an image storage part with the confidential level setting information.

8. The image processing apparatus as claimed in claim 6, wherein by a correspondence table stored in the image storage part, the confidential level setting information is stored by corresponding to the image data.

9. The image processing apparatus as claimed in claim 7, further comprising an encryption pattern storage part storing an encryption pattern corresponding to the encryption degree,
wherein the encryption process part acquires the encryption pattern corresponding to the encryption degree from the encryption pattern storage part and conducts the encryption process with respect to the one or more ranges to be secured, when the image data generated by scanning the original document is printed out or displayed.

10. The image processing apparatus as claimed in claim 9, wherein the encryption process part acquires user information indicating an authentication level corresponding to a confidential level for each user, and conducts the encryption process based on a result from comparing the authentication level with the confidential degree.

11. The image processing apparatus as claimed in claim 5, wherein a preview image of the original document is suppressed to be displayed at a display part, based on the disclosure/non disclosure display.

12. The image processing apparatus as claimed in claim 6, further comprising a decryption process part conducting a decryption process for decrypting one or more encrypted ranges which are portions in the image data, based on the confidential level setting information.

13. The image processing apparatus as claimed in claim 12, further comprising a decryption key storage part storing a decryption key corresponding to the encryption degree, wherein the decryption process part acquires the decryption key corresponding to the encryption degree from the encryption key storage part and conducts the encryption process with respect to the one or more encrypted ranges being secured, when the image data generated by scanning the original document is printed out or displayed.

14. The image processing apparatus as claimed in claim 13, wherein the decryption process part acquires the authentication level from a user information management part managing user information, and conducts the decryption process based on a result from comparing the authentication level with the confidential degree.

15. The image process apparatus as claimed in claim 10, wherein at least one of the image storage part and the user information management part is provided in a server computer accessed through a network.

16. An image processing method for conducting an image process with respect to an image scanned from an original document, comprising the step of:
setting an encryption degree for encrypting contents in a range in the original document to become difficult to visually determine, for each of one or more ranges which are set to partially secure the original document.
